(19) United States
(12) Patent Application Publication
(10) Pub. No.: US 2007/0076321 A1
(43) Pub. Date: Apr. 5, 2007

(54) Data storage system, data storage control device, and failure location diagnosis method thereof

(75) Inventors: Hideo Takahashi, Kawasaki (JP); Norihide Kubota, Kawasaki (JP); Hiroaki Ochi, Kawasaki (JP); Yoshihito Konta, Kawasaki (JP); Yasutake Sato, Kawasaki (JP); Tsukasa Makino, Kawasaki (JP); Mikio Ito, Kawasaki (JP); Hidejirou Daikokuya, Kawasaki (JP); Kazuhiko Ikeuchi, Kawasaki (JP); Shinya Mochizuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/401,244

(22) Filed: Apr. 11, 2006

(30) Foreign Application Priority Data
Sep. 30, 2005 (JP) 2005-286928

(51) Int. Cl. G11B 17/02

(52) U.S. Cl. 360/99.12

(57) ABSTRACT

A storage system has a control module for controlling a plurality of disk storage devices via a transmission path so as to discern the abnormalities of the plurality of disk devices and those of the transmission paths. When a control module for controlling the plurality of disk storage devices detects an error when the disk storage devices are accessed, the control module dummy-accesses the plurality of the disk storage devices on the transmission path, and specifies the suspected failure location based on the result. Therefore it can be discerned whether the suspected failure location is in the transmission path or the disk drive.

### CROSS-REFERENCE TO RELATED APPLICATIONS

This application is based upon and claims the benefit of priority from the prior Japanese Patent Application No. 2005-286928, filed on Sep. 30, 2005, the entire contents of which are incorporated herein by reference.

### BACKGROUND OF THE INVENTION

1. Field of the Invention

The present invention relates to a data storage system used as an external storage device of a computer, the data storage control device, and the failure location diagnosis method thereof, and more particularly to a data storage system where a plurality of disk devices and a control device are connected via transmission paths, the data storage control device, and the failure location diagnosis method thereof.

2. Description of the Related Art

Recently as various data is computerized and handled on computers, an importance of a data storage device (external storage device), which can store large volumes of data efficiently with high reliability, independently from a host computer which executes data processing, is increasing.

For this data storage device, a disk array device, which is comprised of many disk devices (e.g. magnetic disks, optical disks) and a disk controller for controlling these disk devices, is being used. The disk array device can simultaneously receive disk access requests from a plurality of host computers, and control these many disks.

Such a disk array device encloses a memory which plays a role of the cache of the disk. By this, access time to the data when the read request/write request is received from the host computer can be decreased, and high performance can be implemented.

Generally the disk array device has a plurality of major units, that is a channel adapter which is a connection part with the host computer, a disk adapter which is a connection part with a disk drive, a cache memory, a cache control unit for controlling the cache memory, and many disk drives.

If one of these units fails in this complicated system, the failure location must be specified.

FIG. 8 is a diagram depicting a prior art. The disk control device 110 shown in FIG. 8 has two controllers 112 and 114 that include a cache manager (cache memory and cache control unit) 122, and the channel adapter 120 and the disk adapter 124 are connected to each cache manager 122.

The two cache managers 122 are directly connected so that mutual communication is possible. The channel adapter 120 is connected to the host computer 100 via Fiber Channel or Ethernet®. The disk adapter 124 is connected to each disk drive 130-1 and 130-4 in the disk enclosure by FC loops 140 and 142 of the Fiber Channel, for example.

In this configuration, the cache manager 122 executes read or write access to the disk drive 130-3 via such a transmission path 140 as a Fiber Channel by way of the disk adapter 124 based on a request from the host 100.

If an error is detected in the disk drive 130-3 or the disk adapter 124 at this time (e.g. CRC error), conventionally this was regarded as a failure of a disk drive on the FC loop 140, and diagnosis is started. In other words, the FC loop 140 and each disk drive are sequentially disconnected and connected, and the failed disk drive is determined (e.g. Japanese Patent Application Laid-Open No. 2001-306262).

For recent storage systems, however, continuation of operation, regardless where a failure occurs, is demanded in addition to redundancy. In the above prior art, it is difficult to determine whether a failure is in the disk drive 130-3 or in a path of the FC loop 140 (including the disk adapter 124).

Therefore the immediate handling of a failure, such as accessing the disk drive 130-3 from the other controller 114 via the FC loop 142 if the FC loop 140 failed, cannot be performed, which makes continuation of operation difficult.

### SUMMARY OF THE INVENTION

With the foregoing in view, it is an object of the present invention to provide a data storage system having a configuration of a controller and disk drive group connected via transmission paths for specifying the error generation location, whether it is in the disk drive group or the transmission paths, when an error is detected, and the data storage control device, and the failure location diagnosis method thereof.

It is another object of the present invention to provide a data storage system for easily specifying the failure location, whether it is in the disk drive group or the transmission paths, when an error is detected, and the data storage control device, and the failure location diagnosis method thereof.

It is still another object of the present invention to provide a data storage system for specifying a failure location, whether it is in the disk drive group or the transmission paths, when an error is detected, performing alternate processing quickly so as to continue operation, and the data storage control device, and the failure location diagnosis method thereof.

To achieve these objects, the data storage system of the present invention has a plurality of disk storage devices for storing data, and a controller connected to the plurality of disk storage devices via a transmission path for performing access control to the disk storage devices according to an access instruction from a host. And the controller accesses the disk storage devices, detects an error based on the response results from the disk storage devices, dummy-accesses a plurality of disk storage devices connected to the transmission paths on which the disk storage device exists, and specifies whether a suspected failure location is in the disk storage device or the transmission path based on the response results of the dummy-accessed plurality of disk storage devices.

The data storage control device of the present invention has: a control unit connected to a plurality of disk storage devices for storing data via a transmission path, for performing access control to the disk storage devices according to an access instruction from a host; a first interface section for performing an interface control with a host; and a second interface section for performing an interface control with the plurality of disk storage devices. The control unit accesses the disk storage devices, detects an error based on the response results from the disk storage devices, dummy-accesses a plurality of disk storage devices connected to the transmission path on which the disk storage device exists via the second interface section, and specifies whether a suspected failure location is in the disk storage device or the transmission path based on the response results of the dummy-accessed plurality of disk storage devices.

The failure location diagnosis method of the present invention is a failure location diagnosis method for a data storage system, which has a control unit connected to a plurality of disk storage devices that stores data via a transmission path, for performing access control to the disk storage devices according to an access instruction from a host, a first interface section for performing an interface control with the host, and a second interface section for performing an interface control with the plurality of disk storage devices, has the steps of: detecting an error based on the response results from the accessed disk storage devices by the control unit; dummy-accessing a plurality of disk storage devices connected to the transmission path on which the disk storage device exists via the second interface section; and specifying whether a suspected failure location is in the disk storage device or the transmission path based on the response results of the dummy-accessed plurality of disk storage devices.

In the present invention, it is preferable that the controller has a control unit for performing the access control, a first interface section for performing the interface control with the host, and a second interface section for performing the interface control with the plurality of storage devices, wherein the second interface section is connected to the plurality of disk storage devices via the transmission paths.

Also in the present invention, it is preferable that the control unit has a table for storing the attributes of the plurality of disk storage devices connected to the transmission paths, and the control unit detects an error based on the response results from the disk storage device, refers to the table, and selects the plurality of disk storage devices connected to the transmission path to which the error disk storage device exists.

Also in the present invention, it is preferable that the controller detects a CRC error as the error in the response results from the disk storage devices.

Also in the present invention, it is preferable that, according to a read access which the first interface section receives from the host, the control unit accesses the target disk storage device for the read access via the second interface section, and detects an error based on the response result from the disk storage device.

Also in the present invention, it is preferable that, according to a write access which the first interface section receives from the host, the control unit accesses the target disk storage device for the write access via the second interface section, and detects an error based on the response result from the disk storage device.

Also it is preferable that the present invention further has a loop circuit for connecting the plurality of disk storage devices in a loop, and a cable for connecting the second interface section and the loop circuit.

According to the present invention, when an error is detected during access to a disk drive, a plurality of disk devices on the transmission path are dummy-accessed, and the suspected location of the failure is specified based on the results, so it can be discerned whether the suspected location of the failure is in a transmission path or a disk drive.

Also all the disk drives in the transmission path are dummy-accessed and the suspected location of the failure is specified based on this result, so the suspected location of the failure can be specified quickly and easily. Therefore alternate processing can be executed immediately, and operation can be continued.

### BRIEF DESCRIPTION OF THE DRAWINGS

FIG. 1 is a block diagram depicting a data storage system according to an embodiment of the present invention;

FIG. 2 is a block diagram depicting the controller in FIG. 1;

FIG. 3 is a block diagram depicting the transmission paths and disk enclosures in FIG. 1;

FIG. 4 is a diagram depicting the configuration of the FC loop table in FIG. 1 and FIG. 2;

FIG. 5 shows the configuration of the success/failure table in FIG. 1 and FIG. 2;

FIG. 6 is a flow chart depicting the failure location diagnosis processing according to an embodiment of the present invention;

FIG. 7 is a diagram depicting the failure location diagnosis processing operation according to an embodiment of the present invention; and

FIG. 8 is a block diagram depicting a conventional storage system.

### DESCRIPTION OF THE PREFERRED EMBODIMENTS

Embodiments of the present invention will now be described in the sequence of the failure location diagnosis method for a data storage system, configuration of a data storage system, failure location diagnosis processing and other embodiments.

Failure Location Diagnosis Method for Data Storage System:

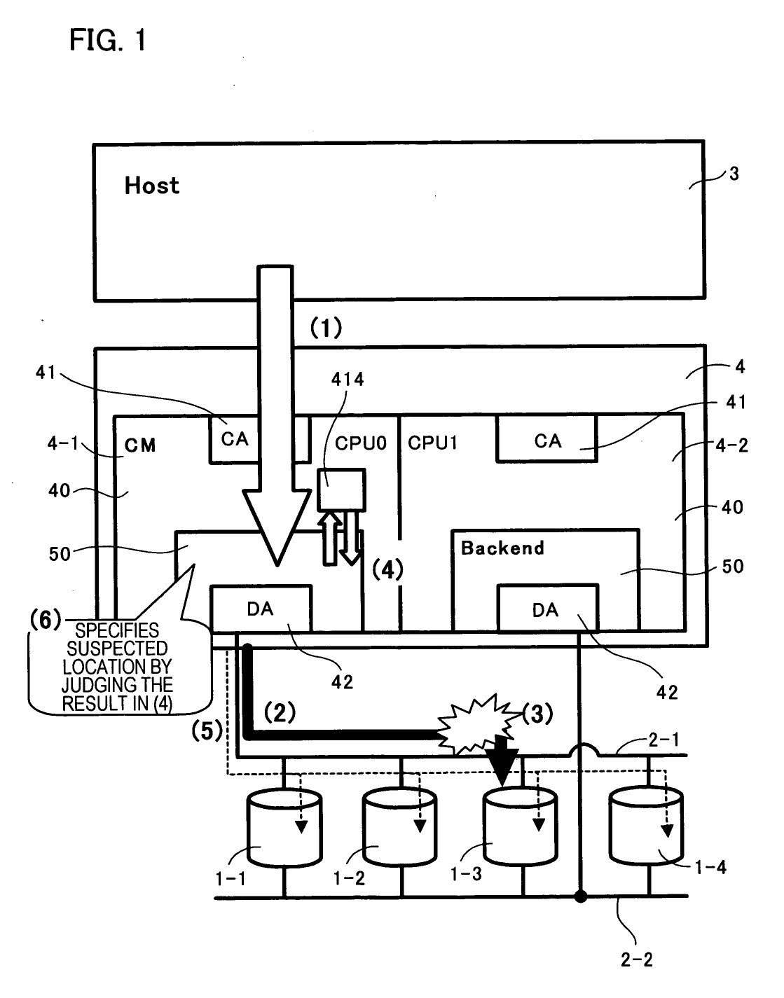

FIG. 1 is a block diagram depicting the data storage device according to an embodiment of the present invention. FIG. 1 shows an example when two controllers are mounted in the storage controller.

As FIG. 1 shows, the storage controller 4 has two control modules 4-1 and 4-2. Each control module 4-1/4-2 further has a channel adapter 41, a cash manager 40 and a disk adapter 42. The two control modules 4-1 and 4-2 are directly connected to each other so that mutual communication is possible. The channel adapter 41 is connected to the host computer 3 via Fiber Channel or Ethernet®. The disk adapter 42 is connected to each disk drive 1-1 through 1-4 in the disk enclosure (mentioned later) via the FC loops 2-1 and 2-2 of the Fiber Channel, for example.

In this configuration, the control module 4-1 performs read or write access to the disk drive 1-3 through the disk adapter 42 based on a request from the host 3 by way of the transmission path 4-1, such as the Fiber Channel.

The control module 4-1 starts diagnosis triggered by the detection of an error, and simultaneously performs dummy-access (disk read access in the case of read) to all the disk drives 1-1 through 1-4 which exist in the FC loop 2-1 on which this erred disk drive 1-3 exists. The control module 4-1 specifies the suspected location based on this result.

In other words, if a CRC (Cyclic Redundancy Check) error is detected in the responses from the plurality of disk drives 1-1 through 1-4, the control module 4-1 determines a failure in a part of the control module (e.g. disk adapter 42) and the path of the FC loop 2-1. In other words, the disk drive 1-3 is normal.

The control module 4-1, on the other hand, determines that a failure is in the disk drive 1-3 if a CRC error is detected only in the disk drive 1-3. The control module 4-1 judges that a part of the control module 4-1 (e.g. disk adapter 42) and the path of the FC loop 2-1 are normal.

Now this diagnosis processing will be described in detail.

(1) The host 3 requests disk access to the controller (cache manager) 40 via the channel adapter 41.

(2) The controller 40 performs disk access to the disk drive 1-3 via the disk adapter 42 and the FC loop 2-1.

(3) An error was generated in this disk access. For example, the disk drive 1-3 or the disk adapter 42 detects a CRC error.

(4) In the back end processing 50 of the controller 40, the table 414, storing disk information, is checked, and information of the plurality of disk drives 1-1 through 1-4 connected to the FC loop 2-1 on which this disk drive 1-3 exists is acquired.

(5) The controller 40 performs dummy-access (read) to all the disk drives 1-1 through 1-4 on this FC loop 2-1.

(6) The controller 40 receives the response result from each disk drive 1-1 through 1-4 via the FC loop 2-1 and disk adapter 42, and specifies the suspected location according to the above mentioned judgment based on these response results.

In this way, when an error is detected during access to a disk drive, the controller 40 dummy-accesses all the disk drives on the transmission path, and specifies the suspected location of the failure, so it can be discerned whether the suspected location of the failure is a transmission path or a disk drive.

Since all the disk drives on the transmission path are dummy-accessed and the suspected location of the failure is specified based on the results, the suspected location of the failure can be specified quickly and easily. Therefore alternate processing can be executed immediately, and operation can be continued.

For example, if it is judged that the failure is in a part of the control module 4-1 (e.g. disk adapter 42) and the path of the FC loop 2-1, the controller 40 accesses the disk drive 1-3 using another disk adapter 42 and FC loop 2-2. If it is judged that the failure is in the disk drive 1-3, the controller 40 accesses the redundant data on another disk drive if the system is in a RAID configuration.

Configuration of data storage system:

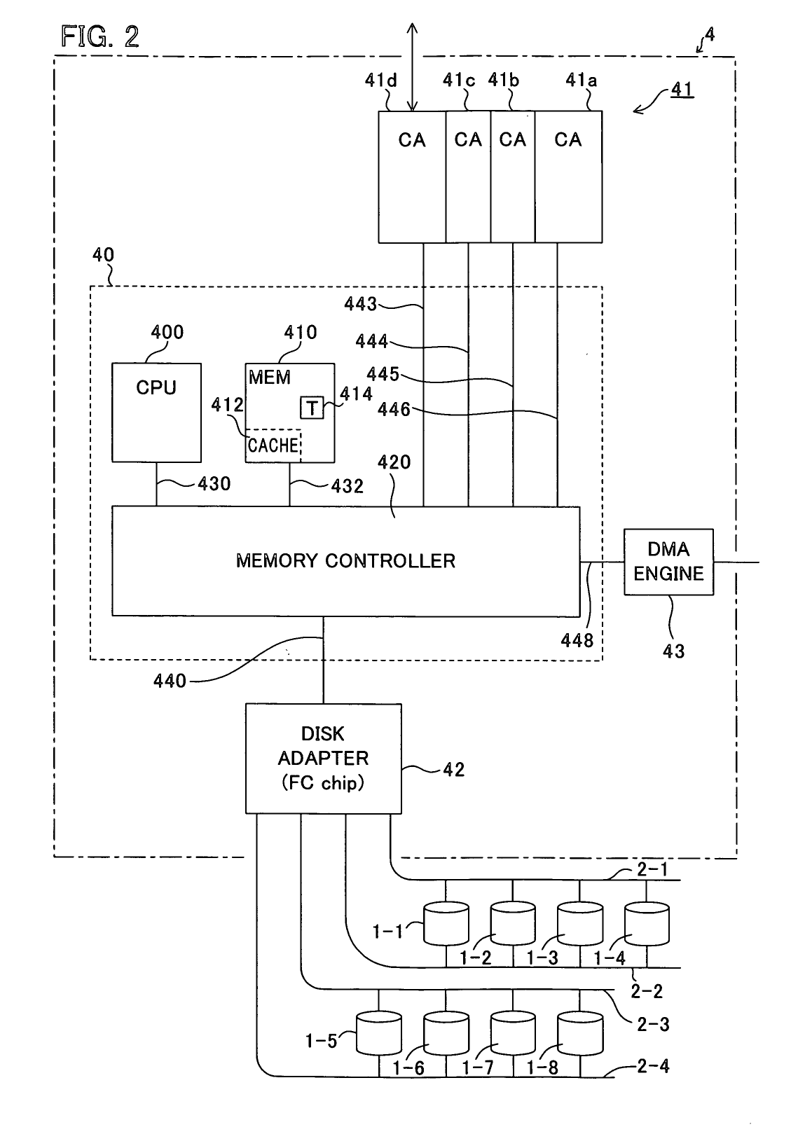

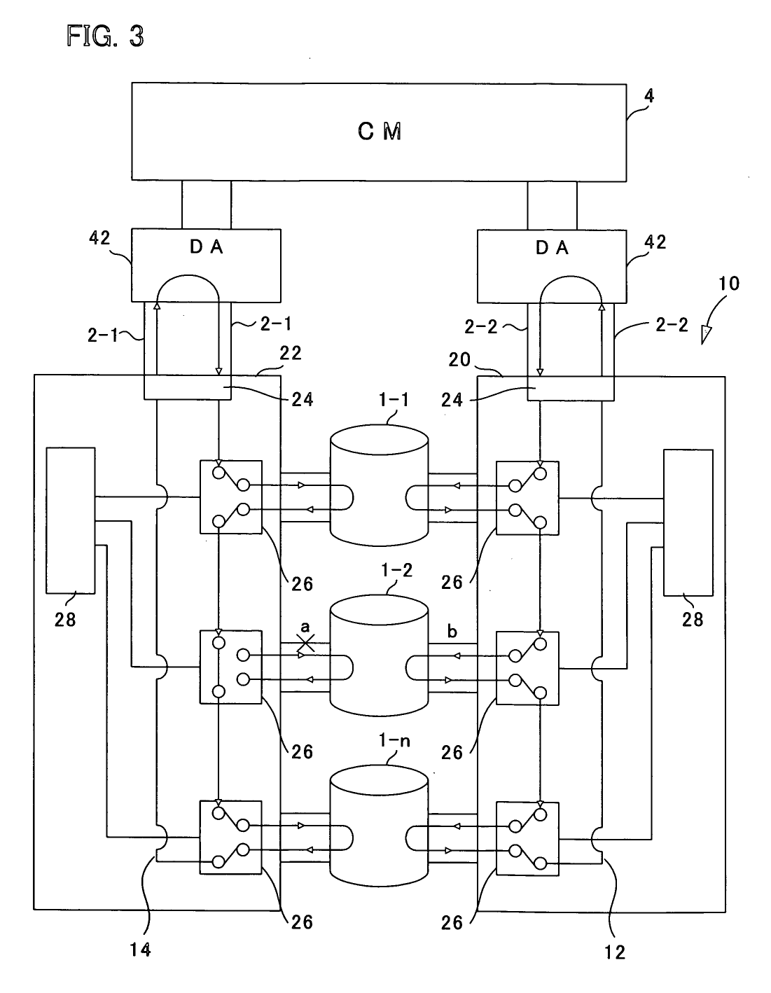

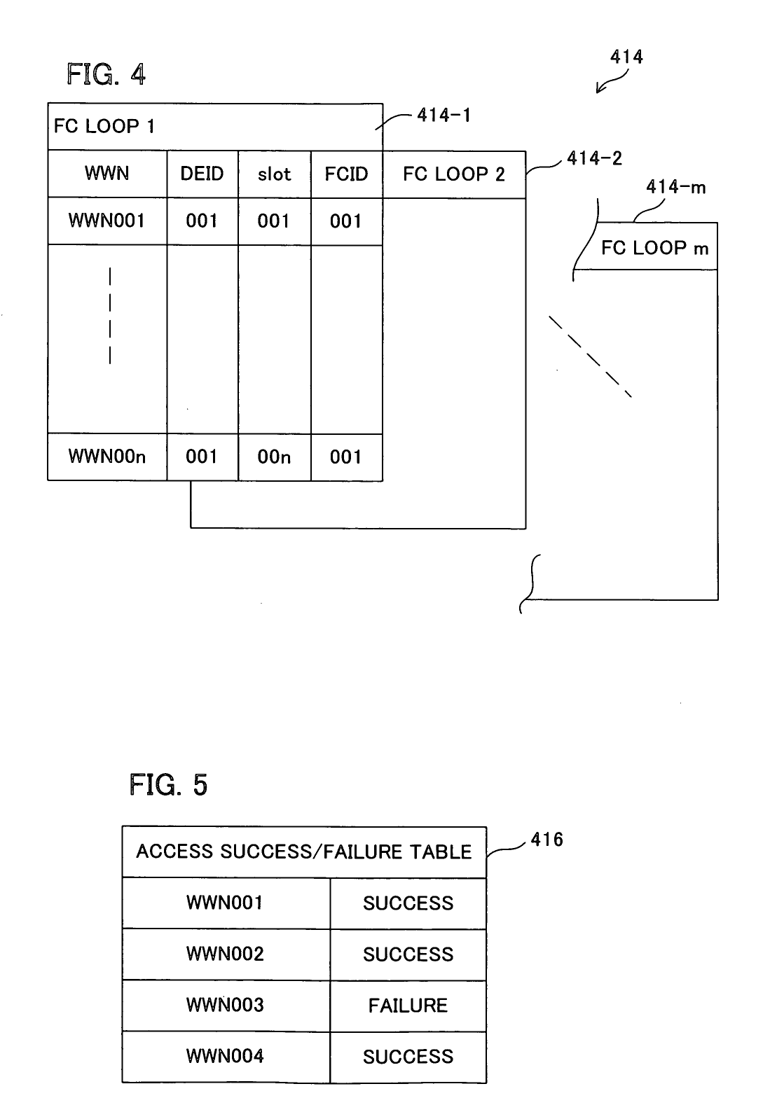

FIG. 2 is a block diagram depicting the control module 4-1/4-2 in FIG. 1, FIG. 3 is a block diagram depicting the FC loop and the disk drive group in FIG. 1, FIG. 4 is a diagram depicting the configuration of the FC loop table in FIG. 1, and FIG. 5 is a configuration of the success/failure table in FIG. 1.

As FIG. 2 shows, each of the control modules 4-1 and 4-2 (hereafter denoted by numeral 4) has a controller 40, a channel adapter (first interface section: hereafter CA) 41, disk adapter (second interface section: hereafter DA) 42a/42b and DMA (Direct Memory Access) engine (communication section: hereafter DMA) 43.

The controller 40 performs read/write processing according to the processing request (read request or write request) from the host computer, and has a memory 410, processing unit 400 and memory controller 420.

The memory 410 has a cache area 412 for holding a part of the data held in a plurality of disk drives of the disk enclosures 20 and 22 described in FIG. 3, that is, for playing a role of a cache for the plurality of disks, an FC loop table 414 and another work area.

The processing unit 400 controls the memory 410, channel adapter 41, device adapter 42 and DMA 43. For this, the processing unit 400 has one or more (one in FIG. 2) CPUs 400 and memory controller 420. The memory controller 420 controls the read/write of the memory 410, and switches the paths.

The memory controller 420 is connected to the memory 410 via the memory bus 432, and is connected to the CPU 400 via the CPU bus 430, and the memory controller 420 is also connected to the disk adapter 42 via the four lines of the high-speed serial bus (e.g. PCI-Express) 440.

In the same way, the memory controller 420 is connected to the channel adapter 41 (four channel adapters 41a, 41b, 41c and 41d in this case) via the four lanes of the high-speed serial buses (e.g. PCI-Express) 443, 444, 445 and 446, and is connected to the DMA 43 via the four lanes of the high-speed serial bus (e.g. ,PCI-Express) 448.

The high-speed serial bus, such as PCI-Express, communicates in packets, and by installing a plurality of lanes of the serial bus, communication with low delay and fast response speed, that is, with low latency, becomes possible even if the number of signal lines is decreased.

The channel adapters 41a through 41d interface with the host computer, and the channel adapters 41a through 41d are connected to different host computers respectively. It is preferable that the channel adapters 41a through 41d are connected to an interface section of the corresponding host computer respectively via a bus, such as Fiber Channel or Ethernet®, and in this case optical fiber or coaxial cable is used for the bus.

Each of these channel adapters 41a through 41d is constructed as a part of each control module 4. Each channel adapter 41a through 41d supports a plurality of protocols as the interface section between the corresponding host computer and the control module 40.

Since the protocol to be mounted is different depending on the corresponding host computer, each channel adapter 41a through 41d is mounted on a different printed circuit board from that of the controller 40, so that each channel adapter can be easily replaced when necessary.

An example of protocol with the host computer to be supported by the channel adapters 41a through 41d is iSCSI (internet Small Computer System Interface) used for Fiber Channel or Ethernet®, as mentioned above.

Also each channel adapter 41a through 41d is directly connected to the controller 40 via a bus 443 through 446 respectively, designed to connect an LSI (Large Scale Integration) and printed circuit board, such as a PCI-Express bus, as mentioned above. By this, high throughput demanded between each channel adapter 41a through 41d and the controller 40 can be implemented.

The disk adapter 42 interfaces with each disk drive of the disk enclosure, and has four FC (Fiber Channel) ports in this case.

Also the disk adapter 42 is directly connected to the controller 40 via a bus designed to connect an LSI (Large Scale Integration) and printed circuit board, such as a PCI-Express bus, as mentioned above. By this, high throughput demanded between the disk adapter 42 and the controller 40 can be implemented.

As shown in FIG. 2, the DMA engine 43 is for communication among each controller 40, such as for mirroring processing.

The transmission paths and the disk drive group will be described with reference to FIG. 3. FIG. 3 shows the disk adapter 42 having four FC ports, which is divided into two sections. As FIG. 3 shows, the disk enclosure 10 has a pair of fiber channel assemblies 20 and 22, and a plurality of magnetic disk devices (disk drives) 1-1 through 1-n.

Each of the plurality of magnetic disk devices 1-1 through 1-n is connected to a pair of fiber channel loops 12 and 14 via the fiber switch 26. The fiber channel loop 12 is connected to the disk adapter 42 of the controller via the fiber channel connector 24 and the fiber cable 2-2, and the fiber channel loop 14 is connected to the other disk adapter 42 of the controller via the fiber channel connector 24 and the fiber cable 2-1.

As mentioned above, both disk adapters 42 are connected to the controller 40, so the controller 40 can access each magnetic disk device 1-1 through 1-n via both routes: one route (route a) is via the disk adapter 42 and the fiber channel loop 12 and the other route (route b) is via the disk adapter 42 and the fiber channel loop 14.

On each fiber channel assembly 20 and 22, the disconnection control section 28 is created. One disconnection control section 28 controls the disconnection (bypass) of each fiber switch 26 of the fiber channel loop 12, and the other disconnection control section 28 controls the disconnection (bypass) of each fiber switch 26 of the fiber channel loop 14.

For example, as FIG. 3 shows, the disconnection control section 28 switches the fiber switch 26 at the port a side of the magnetic disk device 1-2 to bypass status, and disconnects the magnetic disk device 1-2 from the fiber channel loop 14 when port ‘a’ at the fiber channel loop 14 side of the magnetic disk device 1-2 is not accessible. By this, the fiber channel loop 14 functions normally, and the magnetic disk device 1-2 can access through the port ‘b’ at the fiber channel loop 12 side.

Each magnetic disk device 1-1 through 1-n has a pair of FC (Fiber Channel) chips for connecting to port ‘a’ and port ‘b’ respectively, a control circuit, and a disk drive mechanism. This FC chip has a CRC check function.

Here the disk drives 1-1 through 1-4 in FIG. 1 correspond to the magnetic disk devices 1-1 through 1-n in FIG. 3, and the transmission paths 2-1 and 2-2 correspond to the fiber cables 2-1 and 2-2 and the fiber channel assemblies 20 and 22.

As FIG. 4 shows, the fiber channel loop table 414 has map tables 414-1 through 414-m for each fiber channel path 2-1 and 2-2. Each map table 414-1 through 414-m stores WWN (World Wide Number) of the magnetic disk device connected to the fiber channel loop, ID number of the disk enclosure 10 enclosing the magnetic disk device, slot number for indicating the position of the magnetic disk device in the disk enclosure 10, and ID number of the fiber channel loop.

FIG. 5 shows the configuration of the success/failure table 416 created in the memory 410 during the above mentioned diagnosis, and stores the access results as described in (5) for all the magnetic disk devices in the loop as described in (4).

Failure Location Diagnosis Processing:

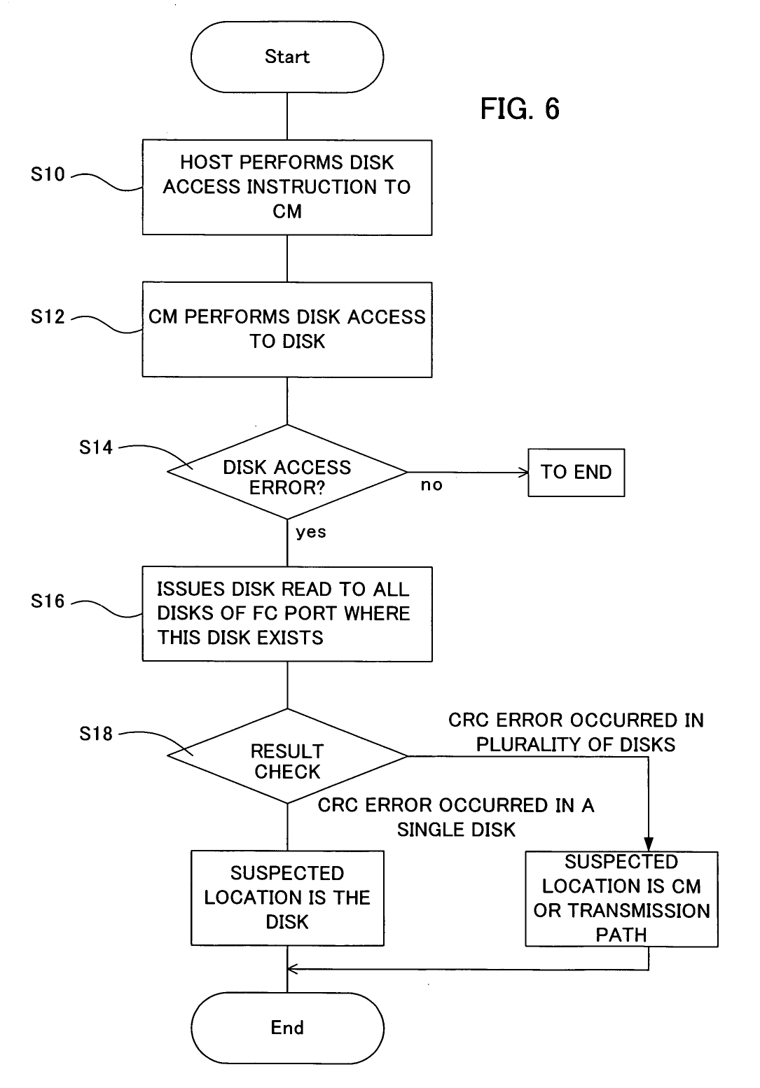

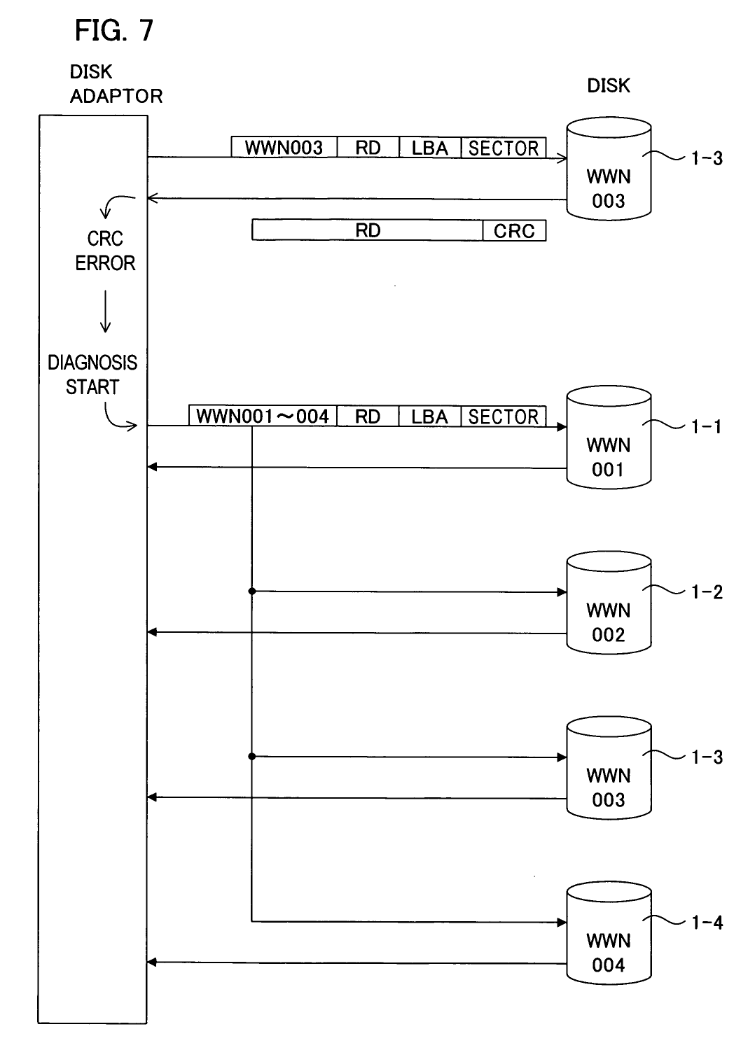

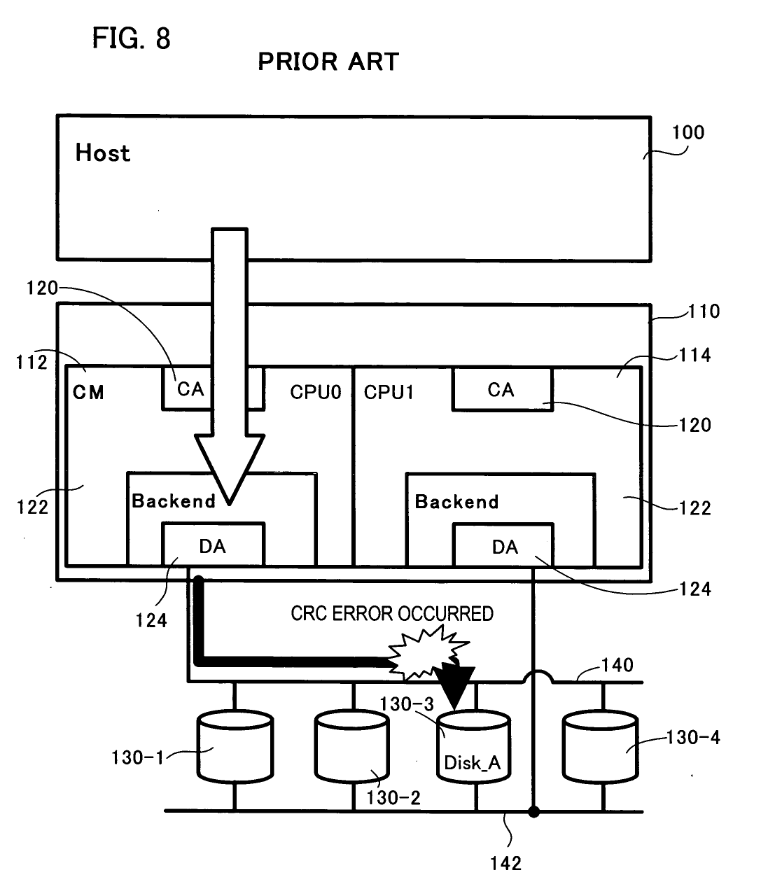

Now the failure location diagnosis processing of the data storage system in FIG. 1 to FIG. 5 will be described using read access as an example. FIG. 6 is a flow chart depicting the failure location diagnosis processing according to an embodiment of the present invention, and FIG. 7 is a diagram depicting the operation thereof.

(S10) When the controller 40 receives the read request from the host computer via the corresponding channel adapter 41a through 41d, and if the cache memory 410 holds the target data of the read request, the controller 40 sends the target data held in the cache memory 410 to the host computer via the channel adapter 41a through 41d.

(S12) If this data is not held in the cache memory 410, the CPU 400 of the controller 40 instructs disk access (read access) to the disk drive holding this target data (1-3 in the example in FIG. 1) via the disk adapter 42, the FC cable 2-1 and the FC channel assembly 22. For example, the CPU 400 instructs DMA transfer to the disk adapter 42. In other words, the CPU 400 of the controller 40 creates the FC header and descriptor in the descriptor area of the memory 410. The descriptor is an instruction to request data transfer to the data transfer circuit, and includes the address on the memory of the FC header, address and data byte count on the cache area 412 of the data to be transferred, and logical address of the data transfer target disk. And the CPU 400 starts up the data transfer circuit in the disk adapter 42. The data transfer circuit, started up in the disk adapter 42, reads the descriptor from the memory 410. The data transfer circuit, started up in the disk adapter 42, reads the FC header and descriptor from the memory 410, decodes the descriptor, and acquires the requested disk (WWW003 in FIG. 7), first address (LBA in FIG. 7) and byte count (SECTOR in FIG. 7), and transfers the FC header from the fiber channel assembly 22 to the target disk drive 1-3 via the fiber channel 2-1.

(S14) The disk drive 1-3 reads the requested target data from the disk, and sends it to the data transfer circuit of the disk adapter 42 via the fiber loop 14 and fiber cable 2-1. The disk adapter 42 checks the CRC of the target data which was sent, and judges whether a disk access error occurred (error was detected in the CRC check). If a disk access error is not detected, the data transfer circuit, started in the disk adapter 42, reads the read data from the memory of the disk adapter 42, and stores it in the cache area 414 of the memory 410. The data transfer circuit notifies completion to the controller 40 by an interrupt when the read transfer completes. Then the controller 40 starts up the DMA transfer circuit in the channel adapter 41, and reads the read data by DMA transfer in the cache area 414 to the host 3 which requested reading.

(S16) When the disk adapter 42 detects the CRC check error, on the other hand, the controller 40 executes failure location diagnosis processing. In other words, the controller 40 refers to the FC loop table 414 in FIG. 4, and acquires the information (WWN) of the plurality of disk drives 1-1 through 1-4 connected to the FC loop 2-1 on which this disk drive 1-3 exists. Then the CPU 400 creates the success/failure table 416 in FIG. 5, in which the acquired information (WWN) of the disk drives 1-1 through 1-4 is written, in the work area of the memory 410. And the controller 40 performs dummy-access (read) to all the disk drives 1-1 through 1-4 on this FC loop 2-1. This read access is the same as step S12, but as FIG. 7 shows, the address is WWN001, 002 003 and 004 of the disk drives 1-1 through 1-4.

(S18) Each disk drive 1-1 through 1-4 reads the requested target data, and sends it to the data transfer circuit of the disk adapter 42 via the fiber loop 14 and fiber cable 2-1. The disk adapter 42 checks the CRC of the target data sent from each disk drive, and judges whether a disk access error occurred (error was detected in the CRC check). The CPU 400 of the controller 40 receives the judgment result and response result from each disk drive 1-1 through 1-4 via the FC loop 2-1 and disk adapter 42, and stores the access result (success/failure) of each disk drive WWN001 through 004 in the success/failure table 416 in FIG. 5 according to the success or failure of the access. Then the CPU 400 judges the suspected failure location based on the response result of each disk drive of the success/failure table 416 in FIG. 5. In other words, if the response result of one disk drive is access failure (e.g. CRC error), the CPU 400 determines that the suspected failure location is the disk drive. If the response results of a plurality of disk drives are access error (e.g. CRC error), on the other hand, the CPU 400 determines that the suspected failure location is either the disk adapter 42 or the transmission path (fiber cable 2-1, fiber channel assembly 22).

In this way, when an error is detected during access to a disk drive, all the disk drives on the transmission path are dummy-accessed, and the suspected location of the failure is specified based on the results, so it can be discerned whether the suspected location of the failure is on a transmission path or a disk drive.

Since all the disk drives on the transmission paths are dummy-accessed and the suspected location of the failure is specified based on the results, the suspected location of the failure can be specified quickly and easily. Therefore alternate processing can be executed immediately, and operation can be continued.

The case of write access is also the same. In this case, the controller 40 performs write access to the target disk drive 1-3 via the disk adapter 42, and the target disk drive 1-3 detects the CRC error, and notifies the CRC error response to the disk adapter 42. By this, diagnosis of the suspected location is started and just like the case of read access, all the disk drives on the transmission path, on which this disk drive exists, are dummy-accessed and written, and the suspected location of the failure is specified based on the write response result.

Failures of transmission paths are, for example, an abnormality of the light emitting section and light receiving section of an FC chip of the disk adapter 42, an abnormality of the FC cable 2-1 and an abnormality of the fiber channel assembly 22. An abnormality of the disk drive 1-3, is, for example, a connection failure of the disk drive 1-3 and an abnormality of the FC chip.

Other Embodiments:

In the above embodiments, the access response error was described as a CRC error, but the present invention can also be applied to other response errors, such as no response for a predetermined time, or a reception error. The number of channel adapters and disk adapters in the control module can be increased or decreased according to necessity. Also dummy-access was performed for all the disk drives on the transmission path, but dummy-access may be performed for two or more drives, that is for a plurality of disk drives, for example.

For the disk drive, a storage device such as a hard disk drive, optical disk drive and magneto-optical disk drive can be used. The configuration of the storage system and the controller (control module) can be applied not only to the configuration in FIG. 1, FIG. 2 and FIG. 3, but to other configurations.

The present invention was described by embodiments, but the present invention can be modified in various ways, and these variant forms shall not be excluded from the scope of the present invention.

When an error is detected during access to a disk drive, all the disk drives on the transmission path are dummy-accessed and the suspected location of the failure is specified based on the results, so it can be discerned whether the suspected location of the failure is on a transmission path or a disk drive.

Since all the disk drives on the transmission path are dummy-accessed and the suspected location of the failure is specified based on the results, the suspected location of the failure can be specified quickly and easily. Therefore alternate processing can be executed immediately, and operation can be continued.

What is claimed is:

1. A data storage system comprising:
a plurality of disk storage device for storing data; and
a control module connected to the plurality of disk storage devices via a transmission path for performing access control to the disk storage devices according to an access instruction from a host,
wherein the control module accesses the disk storage devices, detects an error based on the response results from the disk storage devices, dummy-accesses a plurality of disk storage devices connected to the transmission path on which the disk storage device exists, and specifies whether a suspected failure location is in the disk storage device or the transmission path based on the response results of the dummy-accessed plurality of disk storage devices.

2. The data storage system according to claim 1, wherein the control module comprises:
a control unit for performing the access control;
a first interface section for performing the interface control with the host; and
a second interface section for performing the interface control with the plurality of disk storage devices and is connected to the plurality of disk storage devices via the transmission paths.

3. The data storage system according to claim 2, wherein the control unit comprises a table for storing the attributes of the plurality of disk storage devices connected to the transmission paths,
and wherein the control unit detects an error based on the response results from the disk storage devices, refers to the table, and selects the plurality of disk storage devices connected to the transmission path on which the erred disk storage device exists.

4. The data storage system according to claim 1, wherein the control module detects a CRC error as the error in the response results from the disk storage devices.

5. The data storage system according to claim 3, wherein, according to a read access which the first interface section receives from the host, the control unit accesses the target disk storage device for the read access via the second interface section, and detects an error based on the response result from the disk storage device.

6. The data storage system according to claim 3, wherein, according to a write access which the first interface section receives from the host, the control unit accesses the target disk storage device for the write access via the second interface section, and detects an error based on the response result from the disk storage device.

7. The data storage system according to claim 1, further comprising:
a loop circuit for connecting the plurality of disk storage devices in a loop; and
a cable for connecting the second interface section and the loop circuit.

8. A data storage control device, comprising:
a control unit connected to a plurality of disk storage devices for storing data via a transmission path, for performing access control to the disk storage devices according to an access instruction from a host;
a first interface section for performing an interface control with the host; and
a second interface section for performing an interface control with the plurality of disk storage devices,
wherein the control unit accesses the disk storage devices, detects an error based on the response results from the disk storage devices, dummy-accesses a plurality of disk storage devices connected to the transmission path on which the disk storage device exists via the second interface section, and specifies whether a suspected failure location is in the disk storage device or the transmission path based on the response results of the dummy-accessed plurality of disk storage devices.

9. The data storage control device according to claim 8, wherein the second interface section is connected to the plurality of disk devices via the transmission paths.

10. The data storage control device according to claim 8, wherein the control unit comprises a table for storing the attributes of the plurality of disk storage deices connected to the transmission paths,
and wherein the control unit detects an error based on the response results from the disk storage devices, refers to the table, and selects the plurality of disk storage devices connected to the transmission path on which the erred disk storage device exists.

11. The data storage control device according to claim 8, wherein the control unit detects a CRC error as the error in the response results from the disk storage devices.

12. The data storage control device according to claim 8, wherein, according to a read access which the first interface section receives from the host, the control unit accesses the target disk storage device for the read access via the second interface section, and detects an error based on the response result from the disk storage device.

13. The data storage control device according to claim 8, wherein, according to a write access which the first interface section receives from the host, the control unit accesses the target disk storage device for the write access via the second interface section, and detects an error based on the response result from the disk storage device.

14. The data storage control device according to claim 8, further comprising:
a loop circuit for connecting the plurality of disk storage devices in a loop; and
a cable for connecting the second interface section and the loop circuit.

15. A failure location diagnosis method for a data storage system comprising a control unit connected to a plurality of disk storage devices that store data via a transmission path, for performing access control to the disk storage devices according to an access instruction from a host, a first interface section for performing an interface control with the host, and a second interface section for performing an interface control with the plurality of disk storage devices, comprising the steps of:
detecting an error based on response results from the accessed disk storage devices by the control unit;
dummy-accessing a plurality of disk storage devices connected to the transmission path on which the disk storage device exists via the second interface section; and
specifying whether a suspected failure location is in the disk storage device or the transmission path based on the response results from the dummy-accessed plurality of disk storage devices.

16. The failure location diagnosis method for a data storage system according to claim 15, wherein the step of dummy-accessing comprises:
a step of referring to a table that stores the attributes of the plurality of disk storage devices connected to the transmission paths; and
a step of selecting a plurality of disk storage devices connected to the transmission path on which the erred disk storage device exists.

17. The failure location diagnosis method for a data storage system according to claim 15, wherein the step of specifying comprises a step of detecting a CRC error as the error of the response result of the disk storage device.

18. The failure location diagnosis method for a data storage system according to claim 15, wherein the step of detecting an error comprises:
a step of accessing the target disk storage device for a read access via the second interface section according to the read access which the first interface section receives from the host; and
a step of detecting an error based on the response result from the disk storage device.

19. The failure location diagnosis method for a data storage system according to claim 15, wherein the step of detecting an error comprises:
a step of accessing the target disk storage device for a write access via the second interface section according to the write access which the first interface section receive from the host; and
a step of detecting an error based on the response result from the disk storage device.

20. The failure location diagnosis method for a data storage system according to claim 15, wherein the step of dummy-accessing comprises a step of dummy-accessing via a loop circuit for connecting the plurality of disk storage devices in a loop, and a cable for connecting the second interface section and the loop circuit.
